(19) United States
(12) Patent Application Publication
(10) Pub. No.: US 2026/0291313 A1
(43) Pub. Date: Sep. 24, 2026

(54) Electrical Machine

(71) Applicant: Bayerische Motoren Werke Aktiengesellschaft, Muenchen (DE)

(72) Inventors: Benjamin KRANK, Emmering (DE); Matthias LEPSCHI, Muenchen (DE); Johannes MEYER, Karlsfeld (DE)

(21) Appl. No.: 18/998,022

(22) PCT Filed: Jul. 26, 2023
(86) PCT No.: PCT/EP2023/070746

§ 371 Date: Jan. 23, 2025

(30) Foreign Application Priority Data
Sep. 1, 2022 (DE) 10 2022 122 183.0

(51) Int. Cl. H02K 1/32

(52) U.S. Cl. CPC H02K 1/32

(57) ABSTRACT

An electrical machine having a rotor on a rotor shaft and a support ring on an end face of the rotor, wherein at least one conduit in the support ring includes a collection structure.

### BACKGROUND AND SUMMARY

The present disclosure relates to an electric machine with a rotor arranged on a rotor shaft and with a supporting ring arranged on the front of the rotor, wherein a routing duct arranged in the supporting ring has a collecting structure.

Electric machines can be employed as operational machines for motor vehicles that are capable of being propelled electrically—for instance, electric vehicles and hybrid vehicles. In this connection, electric machines in diverse manifestations may find application, an electric machine typically having a stator, mounted in stationary manner, and a rotor, mounted so as to be movable with respect to the stator. In the case of current-excited electric machines, active components have magnetic-field-generating systems, for instance in the form of energizable windings which are held by an iron core, in order to generate a magnetic flux.

Such windings may heat up during the operation of the electric machine, as a result of which local hotspots may arise, for instance by reason of an inhomogeneous temperature distribution in the winding. Since a heating of the electric machine may adversely influence efficiency and continuous output, solutions are known for cooling the electric machine. For instance, for the purpose of cooling the rotor, a cooling jacket which is flowed through by cooling medium may have been arranged around the rotor, or the rotor may have a shaft which takes the form of a hollow shaft which is flowed through by a cooling medium.

It is an object of the present disclosure to improve the cooling of an electric machine.

This object is achieved by an electric machine with the features disclosed herein. The present disclosure also relates to advantageous developments.

According to a first aspect, an electric machine with a rotor arranged on a rotor shaft and with a supporting ring arranged on the front of the rotor is specified, wherein at least one routing duct arranged in the supporting ring has a collecting structure which has been configured to route a fluid emitted from the rotor shaft to a front side of the supporting ring.

The supporting ring may have been arranged on and/or fastened to the rotor and/or the rotor shaft, as a result of which a transfer of heat between the supporting ring and the respective component of the electric machine can take place. In particular, the supporting ring displays aluminum, or has been manufactured therefrom, in order to assist a transfer of heat between the fluid, the supporting ring and, in particular, further components, particularly if the supporting ring has been connected to the rotor or to another component of the electric machine in thermally conducting manner.

The fluid emitted from the rotor shaft can be taken up by the routing duct and transported to the collecting structure, in particular by centrifugal force. By virtue of the fact that the collecting structure has been configured to direct the fluid to a front side of the supporting ring, heat arising in the rotor can be taken up and transported away by the fluid. By this, a cooling capacity of the rotor is improved, and consequently a homogenized temperature-level can be set. The fluid can, for instance, be transported, or routed, along the front side of the supporting ring, or of the rotor, facing toward and/or away from the rotor. The fluid is able to flow outward substantially radially along the front side.

The coolant can be conducted directly onto, or very close to, places to be cooled. In particular, a flow of coolant may arise that is able to provide for a dissipation of heat.

For the purpose of cooling the electric machine, the rotor shaft has been designed to be flowed through by fluid and may, for instance, have been constructed as a rotating hollow shaft, flowed through by a fluid or cooling medium, around which the rotor, or the supporting ring, is arranged in torsion-resistant manner. The fluid is, in particular, an electrically non-conducting coolant—for instance, oil. The fluid can be withdrawn from a coolant circuit or from a lubricant circuit, in particular in order not to impair the functionality of the electric machine in the event of direct contact with current-carrying components.

The rotor shaft may have at least one outlet, or at least one outlet opening, for emitting coolant from the hollow shaft of the rotor. During a rotary movement of the rotor, the fluid from the rotor shaft can be transported radially outward by centrifugal force, in order to wet machine components and consequently to make a transfer of heat possible. The routing duct, or routing ducts, of the supporting ring may have been assigned to this outlet, or to these outlet openings, in order to take up fluid from the rotor shaft and to emit it to the front side of the supporting ring, or to collecting structures arranged there.

The electric machine can be employed as, for instance, an electric traction machine for a motor vehicle that is capable of being operated electrically. The electric machine takes the form of, in particular, a current-excited synchronous machine (SSM) or an asynchronous machine (ASM). The electric machine may have a stator, mounted in stationary manner, and also a rotor, mounted so as to be movable—in particular, rotatable—with respect to the stator. The rotor has an iron component which, for instance, may have been formed by a bundle of rotor laminations consisting of axially stacked sheet-metal lamellae. In addition, the rotor may have an electrically conductive winding that has been designed for the generation, or excitation, of a magnetic flux for carrying current. For instance, in the case of a current-excited synchronous machine the winding may take the form of an energizable excitation coil.

An interior space of the electric machine is bounded by a housing. Fluid, or coolant, may consequently be located in the interior space of the electric machine, and it is possible to speak of a wet electric machine—in particular, a wet electric motor. In particular, the rotor and also the stator are arranged in the interior space, and the fluid can interact directly with the components of the electric machine that are to be cooled in the interior space of the electric machine.

The present disclosure is partly based on the idea of routing the fluid, or coolant, emitted from the rotor shaft to the front side of the supporting ring, or of conducting it past this side or this ring, by the collecting structure, in the course of which a suction effect, caused by centrifugal force, in the course of a rotary movement of the rotor can, in particular, be utilized, in order to constantly relocate the fluid. By virtue of the thermal connection created in this way between the fluid and the supporting ring and/or components to be cooled, such as the rotor for instance, heat arising in operation can be conducted away and extracted from the system. The supporting ring may have been arranged at an axial end of the rotor, at which, in particular, winding heads of rotor windings may have been arranged which may constitute hotspots during the operation of the rotor. In some embodiments, two supporting rings may have been provided which may have been arranged on two front faces of the rotor arranged opposing one another.

By virtue of an arrangement, or configuration, of the collecting structure, a mass flow of the fluid, which is, or is to be, routed through the front side of the supporting ring, can, for instance, be predetermined. Consequently a temperature distribution in the electric machine can be homogenized, and/or local hotspots can be avoided. As a result, an efficiency and/or a continuous output, for instance, of the electric machine can be boosted. In addition, the targeted routing of the fluid to predetermined regions of the supporting ring can relieve the load on a coolant pump arranged outside the electric machine, so that this pump can be designed to be smaller and lighter.

In one practical form, the supporting ring has been arranged on the rotor shaft by a hub, and the at least one routing duct is arranged on the hub of the supporting ring. The hub has been molded radially on the inside of the supporting ring and has a predetermined length in the axial direction, in order to enable a secure fit on the rotor shaft and/or a take-up, or transport, of rotor-shaft fluid. For this purpose, the hub has an inside diameter that, in particular, corresponds substantially to an outside diameter of the rotor shaft, in order to be capable of being fixed to the rotor shaft. The at least one routing duct, or the routing ducts, of the supporting ring has/have, in particular, been assigned to one or more fluid outlet openings of the rotor shaft, or is/are arranged adjoining these openings, in order to make possible a guidance of fluid through the routing duct or ducts.

By virtue of a substantially washer-shaped design, the supporting ring can be arranged axially on a front side of the rotor, in order to make a space-saving arrangement possible and to keep an axial dimension of the electric machine small. In some embodiments, the supporting ring extends radially as far as an outside diameter of the rotor shaft, as a result of which a maximized surface area of the front face can be made available for the routing of fluid, in order to make an enhanced cooling performance possible.

In one practical form, the at least one routing duct is arranged on a region between the hub and the front side of the supporting ring, with the routing duct leading into the collecting structure, in particular, in a plane of the supporting ring. The collecting structure may have been formed in this transition region—in particular, at the front and/or on the hub—so that the fluid can be routed, for instance through routing ducts provided in the hub, toward the front side of the supporting ring and can be collected there in the collecting structure. By this, fluid is able to collect, in particular due to cohesion, in a radially inner region of the supporting ring, in order then to flow, or to be routed, in particular due to adhesion, along the surface of the front side of the supporting ring, in order to cool this surface.

In one practical form, the at least one routing duct includes an acute angle with the rotor axis. By this, an acceleration of the fluid can be decreased, in order to assist a collecting of the fluid at the end of the routing duct. In addition, the fluid can be routed in a direction toward the front face of the supporting ring, in order to assist a collecting and routing of the fluid along the front face. In some practical forms, the routing duct may, additionally or alternatively, include an acute angle with respect to a radial line of the supporting ring, in order to adapt a flow direction and/or flow speed of the fluid.

In one practical form, the collecting structure takes the form of a depression in the supporting ring. This depression may have been configured to collect the fluid emitted from the rotor shaft and to route it to the front side of the supporting ring, for instance via rounded and/or radially oriented transition surfaces. The fluid captured or collected in this way can be routed to the front side or may flow along it, in order to make an exchange of heat possible there.

For this purpose, the depression may, for instance, have a structure facing away from the rotor shaft, or from an outlet of the rotor shaft, in particular in the form of a recess, trough or groove, which has been configured to collect fluid flowing in the radial direction through the routing duct or ducts, or to prevent it from splashing when emerging from the routing duct or ducts and missing the front side of the supporting ring or only reaching it to an unsatisfactory extent.

In some practical forms, the collecting structure may take the form of an elevation, in particular in the form of an embankment, a dike, a slope or a lip, in order to collect the fluid and/or to route it to the front side of the supporting ring.

In one practical form, the depression is arranged at a radially outer end of the routing duct, in order to collect the fluid on the front side, in particular facing away from the rotor. By virtue of the collecting of the fluid by the collecting structure, fluid can be prevented, at least partially, from running or flying past the supporting ring, as a result of which the efficiency of the cooling can be increased. In addition, a flow of fluid over the surface of the front face can be made uniform, in order to make a uniform cooling of the supporting ring possible.

In one practical form, the depression is arranged in offset manner with respect to the routing duct, contrary to a direction of rotation of the rotor. The collecting structure, or the depression, may have been configured to influence the trajectory of a stream of the emitted fluid in a predetermined direction, in order to be routed to a target region, in particular on the front side of the supporting ring. By the offset arrangement, or asymmetrical design, of the depression, or of the collecting structure, a flow of fluid over the front face can be made possible that is optimized for the direction of rotation.

In other practical forms, the depression, or collecting structure, may have been arranged uniformly, or symmetrically, around an outlet of the routing duct, or routing ducts, in order to permit a uniform, or homogeneous, distribution of fluid over the front face of the supporting ring in the course of operation of the electric machine in both possible directions of rotation.

In one practical form, a plurality of routing ducts are arranged on the supporting ring in rotationally symmetrical manner. In this case, six or twelve routing ducts, for instance, may have been provided, in particular on the hub of the supporting ring, in order to be able to make an optimized flow of fluid possible for a rotor with six windings. In addition, two routing ducts may have been respectively assigned to, or may lead into, a collecting structure, in order to be able to provide a feeding of the collecting structure in a manner that is optimized for the direction of rotation. In this case, the pair of routing ducts may have different angles with respect to the rotor axis, or to a radial line of the supporting ring, and/or different cross sections, in order to improve a guidance of fluid.

According to a further aspect, a supporting ring for an electric machine is proposed that has been configured for use in an electric machine described herein. In particular, the supporting ring has been formed in a manner described herein, in particular as disclosed with reference to the practical forms and/or embodiments of the electric machine described herein. By such a supporting ring, a homogenized cooling of an electric machine can be made possible.

The practical forms and advantages described herein apply correspondingly to a motor vehicle having such an electric machine.

Further features of the present disclosure arise from the claims, from the Figures and from the description of the Figures. The features and combinations of features mentioned above in the description, and also the features and combinations of features mentioned below in the description of the Figures, and/or shown in the Figures alone, are capable of being used not only in the respectively specified combination but also in other combinations or on their own. Further advantages and possible applications of the present disclosure will become apparent from the following description in conjunction with the Figures.

### BRIEF DESCRIPTION OF THE DRAWINGS

FIG. 1 shows a schematic sectional representation of an exemplary embodiment of an electric machine according to various embodiments.

FIG. 2 shows a schematic representation of an exemplary embodiment of a supporting ring according to various embodiments.

FIG. 3 shows a schematic representation of another exemplary embodiment of a supporting ring according to various embodiments.

### DETAILED DESCRIPTION OF THE DRAWINGS

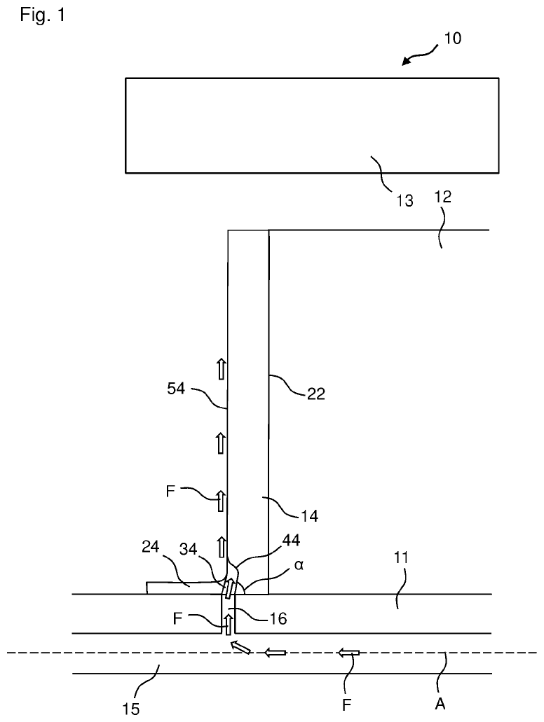

FIG. 1 shows a schematic sectional representation of a section of an exemplary embodiment of an electric machine 10 according to various embodiments.

The electric machine 10 has a rotor 12 arranged on a rotor shaft 11, a stator 13 and a flow element 14. The rotor shaft 11 has a hollow space 15 through which fluid is capable of flowing and from which a fluid F, or coolant, (symbolized by arrows) is capable of being emitted from the rotor shaft 11 via an outlet 16.

The supporting ring 14 has been arranged by a hub 24 of the rotor shaft 11 and may be in communication in thermally conducting manner with a front side 22 of the rotor 12. A routing duct 34, or its collecting structure 44, arranged in the supporting ring 14 has been configured to route the fluid F—emerging, in particular, by virtue of centrifugal forces arising in the course of a movement of the rotor, and flowing through the routing duct 34—to a front side 54 of the supporting ring 14. The routing duct 34 is arranged in a region between the hub 24 and the front side 54 of the supporting ring 14, and leads into the collecting structure 44 arranged at a radially outer end of the routing duct 34. The routing duct 34 includes an acute angle α with the rotor axis A (in the representation, angle α has been drawn in with respect to a wall of the rotor shaft 11, for better readability).

The collecting structure 44 takes the form of a depression in the supporting ring 14 and has been configured to collect the fluid F emitted from the rotor shaft 11 in order to route it to the front side 54 of the supporting ring 14, in order to be able to cool this side in targeted manner.

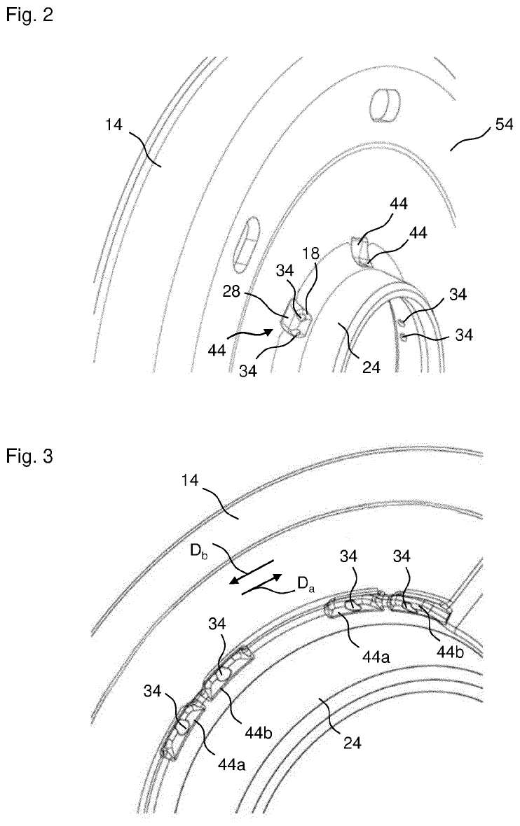

FIG. 2 shows a schematic representation of an exemplary embodiment of a supporting ring 14 according to the present disclosure for an electric machine 10.

The supporting ring 14 takes the form substantially of a washer with a hub 24, and has collecting structures 44 at a transition between the hub 24 and its front side 54, in order to collect fluid F flowing out from a rotor shaft 11 and to route it to the front side 54 of the supporting ring 14. For this purpose, two routing ducts 34 lead respectively into a collecting structure 44 taking the form of a depression in the supporting ring 14. The depression is arranged symmetrically around the routing ducts 34. By virtue of the depression 44, radial collecting walls 18 have been formed in the supporting ring 14 on the hub side, which can serve to catch fluid F spraying out of the routing ducts 34 by virtue of the rotary movement caused by operation, and can consequently prevent an uncontrolled discharge. In addition, by the depression 44 a collecting tray 28, set back axially with respect to the front side 54, has been formed on the front side, which can contribute to collecting the fluid F. The depression, or collecting structure 44, and/or the collecting walls 18 and/or collecting tray 28 thereof may, for instance, have rounded and/or radially oriented transition surfaces, in order to route fluid F to the front side 54 of the supporting ring 14.

FIG. 3 shows a schematic representation of a further exemplary embodiment of a supporting ring 14 according to the present disclosure for an electric machine 10, which corresponds in its fundamentals to the supporting ring 14 shown in FIG. 2.

The supporting ring 14 has routing ducts 34 which have been configured to route a stream of fluid F in a radial direction, in order to make possible a transfer of heat to the fluid F on the front side 54 of the supporting ring 14. To each of the routing ducts 34 arranged radially, in particular symmetrically, in distributed manner on the hub 24, a collecting structure 44 has been assigned, in order to route the fluid F emitted from the rotor shaft 11 to the front side 54 of the supporting ring 14. The collecting structure 44 taking the form of a depression is arranged in offset manner with respect to the routing duct 34, first collecting structures 44a being arranged in a first direction of rotation Dₐ, and second collecting structures 44a being arranged in a second direction of rotation D_{b}, in offset manner with respect to the respective routing duct 34, or the outlet thereof. This may have been formed, in particular, by virtue of the fact that the depression 44 has a larger volumetric capacity in relation to the respective routing duct 34 on a side opposite the direction of rotation Dₐ, D_{b} than in the direction of rotation Dₐ, D_{b}. By this, a distribution of fluid can be made possible in a manner that is adapted to the direction of rotation.

### LIST OF REFERENCE SYMBOLS

10 electric machine
11 rotor shaft
12 rotor
13 stator
14 supporting ring
15 hollow space
16 outlet
18 collecting walls
22 front side of the rotor
24 hub
28 collecting tray
34 routing duct
44 collecting structure
54 front side
A rotor axis
Dₐ, D_{b} direction of rotation
F fluid
α angle

1-9. (canceled)

10. An electric machine comprising:
a rotor arranged on a rotor shaft;
a supporting ring arranged on a front side of the rotor; and
at least one routing duct arranged in the supporting ring that has a collecting structure configured to route a fluid emitted from the rotor shaft to a front side of the supporting ring.

11. The electric machine according to claim 10,
wherein the supporting ring is arranged on the rotor shaft by a hub, and
wherein the at least one routing duct is arranged on the hub of the supporting ring.

12. The electric machine according to claim 11,
wherein the at least one routing duct is arranged in a region between the hub and the front side of the supporting ring.

13. The electric machine according to claim 10,
wherein the at least one routing duct includes an acute angle with an axis of the rotor.

14. The electric machine according to claim 10,
wherein the collecting structure has a form of a depression in the supporting ring.

15. The electric machine according to claim 14, wherein the depression is arranged at a radially outer end of the at least one routing duct.

16. The electric machine according to claim 14,
wherein the depression is arranged in an offset manner with respect to the at least one routing duct, contrary to a direction of rotation of the rotor.

17. The electric machine according to claim 10, comprising:
a plurality of routing ducts arranged on the supporting ring in a rotationally symmetrical manner.

18. A supporting ring for an electric machine, wherein the electric machine includes a rotor arranged on a rotor shaft,
wherein the supporting ring is configured to be arranged on a front side of the rotor of the electric machine, and
wherein the supporting ring comprises:
at least one routing duct arranged in the supporting ring that has a collecting structure configured to route a fluid emitted from the rotor shaft to a front side of the supporting ring.

19. The supporting ring according to claim 18,
wherein the supporting ring is configured to be arranged on the rotor shaft by a hub, and
wherein the at least one routing duct is arranged on the hub of the supporting ring.

20. The supporting ring according to claim 19,
wherein the at least one routing duct is arranged in a region between the hub and the front side of the supporting ring.

21. The supporting ring according to claim 18,
wherein the at least one routing duct includes an acute angle with an axis of the rotor.

22. The supporting ring according to claim 18,
wherein the collecting structure has a form of a depression in the supporting ring.

23. The supporting ring according to claim 22, wherein the depression is arranged at a radially outer end of the at least one routing duct.

24. The supporting ring according to claim 22,
wherein the depression is arranged in an offset manner with respect to the at least one routing duct, contrary to a direction of rotation of the rotor.

25. The supporting ring according to claim 18, comprising:
a plurality of routing ducts arranged on the supporting ring in a rotationally symmetrical manner.
